(19) United States
(12) Patent Application Publication
(10) Pub. No.: US 2002/0139648 A1
(43) Pub. Date: Oct. 3, 2002

(54) Multifunctional lever stalk

(76) Inventors: Steven R. Hoskins, Walled Lake, MI (US); Joseph E. Khoury, Stromberg (DE)

Correspondence Address: BLANK ROME COMISKY & MCCAULEY, LLP, 900 17TH STREET, N.W., SUITE 1000, WASHINGTON, DC, 20006, US

(21) Appl. No.: 09/824,344

(22) Filed: Apr. 2, 2001

(51) Int. Cl. H01H 9/00

(52) U.S. Cl. 200/61.54

(57) ABSTRACT

A multifunctional automobile steering column lever having a printed circuit board and a variety of different input devices designed to achieve a desired grouping of functionality. To this end, the multifunctional automobile lever comprises: (i) a housing for attachment to a steering column of an automobile; (ii) a printed circuit board fixed inside the housing; (iii) a pushbutton displayed by the housing and adapted to make an electrical connection with the printed circuit board; (iv) a thumbwheel displayed by the housing and adapted to make an electrical connection with the printed circuit board; and (v) a rocker button displayed by the housing and adapted to make an electrical connection with the printed circuit board.

### BACKGROUND OF THE INVENTION

1. Field of the Invention

The present invention relates generally to automobile lever assemblies. More particularly, the present invention relates to automobile lever assemblies having multiple functions.

2. Discussion of the Background

Automobiles commonly provide one or more functional levers or stalks that extend outwardly from the steering column. One well known functional lever operates the turn signals. In many instances, the levers are multifunctional. For instance, an automobile manufacturer may wish to combine the turn signal lever with the head light controls, so that pivoting the turn signal lever in one plane controls the turn signals, while moving the turn signal lever in another plane toggles the headlights between normal lighting and fog lighting.

Another well known multifunctional lever controls windshield wiping and cleaning. The levers typically enable the driver to turn the front and/or rear windshield wipers on as well as to set the speed of one or both of the front and rear windshield wipers. The levers also typically enable the driver to operate the front and/or rear window wash alone or in combination with the wipers. Since in many instances the driver will be operating the wipers and the wash in bad driving conditions, an important feature of the windshield wiper lever is that it be fully operable with one hand and without requiring the driver to observe the lever.

While known turn signal levers and wiper levers perform multiple functions, a continuing need exists to add and combine more functionality in steering wheel levers and to make the assembly of the levers simpler and more robust. Further, as functionality in the lever increases, the components must be displayed to the driver as intuitively as possible.

Known steering column stalks contain complicated circuitry requiring complex tooling and assembly. Certain known systems contain multiple printed circuit boards (“PCB's”) and multiple sliding and/or rotating contact carriers, whereby the manufacturer must electrically link the multiple boards, ground each board and run the wires so that they do not interfere with the moving carriers. Packaging the same functionality using a simpler system that eliminates even a small amount of these components and assembly steps provides a substantial benefit to manufacturers. Accordingly, a need exists to provide more functionality in a single steering wheel lever or stalk. Further, a need exists to make the levers as robust, simple, easily assembled, intuitive and as visible as possible.

### SUMMARY OF THE INVENTION

The present invention provides an improved multifunctional automobile steering column lever. More specifically, the present invention provides an improved multifunctional automobile steering column lever having a printed circuit board and a variety of different input devices designed to achieve a desired grouping of functionality.

To this end, in an embodiment of the present invention, a multifunctional automobile lever comprises: (i) a housing for attachment to a steering column of an automobile; (ii) a printed circuit board fixed inside the housing; (iii) a pushbutton displayed by the housing and adapted to make an electrical connection with the printed circuit board; (iv) a thumbwheel displayed by the housing and adapted to make an electrical connection with the printed circuit board; and (v) a rocker button displayed by the housing and adapted to make an electrical connection with the printed circuit board.

In one alternative of this embodiment the pushbutton is adapted to make a latching electrical connection with the printed circuit board. In another, the pushbutton is adapted to make a momentary electrical connection with the printed circuit board. A further alternative of this embodiment includes a plurality of pushbuttons, each adapted to make an electrical connection with the printed circuit board.

In one alternative of this embodiment, the thumbwheel is adapted to make a plurality of electrical connections with the printed circuit board. Another alternative of this embodiment includes a slide switch displayed by the housing and adapted to make an electrical connection with the printed circuit board.

In one alternative of this embodiment, the rocker button is adapted to make a plurality of electrical connections with the printed circuit board. In another, the rocker button is adapted to make a latching electrical connection with the printed circuit board. In a further, the rocker button is adapted to make a momentary electrical connection with the printed circuit board.

In one alternative of this embodiment, at least a portion of the housing is translucent. In another, the housing includes graphics adapted to be illuminated. In a further, the housing is angled so that a front facing input device thereon appears substantially horizontal. In an alternative of this embodiment, a front facing input device is angled to appear substantially horizontal.

In another embodiment of the present invention, a multifunctional automobile lever comprises: (i) a housing for attachment to a steering column of an automobile; (ii) a printed circuit board fixed inside the housing; (iii) a slide switch displayed by the housing and adapted to make an electrical connection with the printed circuit board; (iv) a thumbwheel displayed by the housing and adapted to make an electrical connection with the printed circuit board; and (v) a rocker button displayed by the housing and adapted to make an electrical connection with the printed circuit board.

One alternative of this embodiment includes a plurality of slide switches, each adapted to make an electrical connection with the printed circuit board. In another alternative of this embodiment, at least a portion of the housing includes graphics adapted to be illuminated.

In a further embodiment of the present invention, a multifunctional automobile lever comprises: (i) a housing for attachment to a steering column of an automobile; (ii) a printed circuit board fixed inside the housing; (iii) a plurality of pushbuttons, each displayed by the housing and adapted to make an electrical connection with the printed circuit board; and (iv) a thumbwheel displayed by the housing and adapted to make an electrical connection with the printed circuit board.

One alternative of this embodiment includes a slide switch moveably attached to the housing and adapted to make an electrical connection with the printed circuit board.

In yet another embodiment of the present invention, a windshield wiper control lever comprises: (i) a housing for attachment to a steering column of an automobile; (ii) a printed circuit board fixed inside the housing; (iii) a momentary pushbutton displayed by the housing and adapted to make an electrical connection with the printed circuit board, wherein the pushbutton connection is adapted to enable a windshield wiper wash; and (iv) a thumbwheel displayed by the housing and adapted to make a plurality of electrical connections with the printed circuit board, wherein the thumbwheel connections are adapted to enable different wiper speeds to be set.

In yet a further embodiment of the present invention, a radio controller for an automobile comprises: (i) a housing for attachment to a steering column of an automobile; (ii) a printed circuit board fixed inside the housing; (iii) a pushbutton displayed by the housing and adapted to make an electrical connection with the printed circuit board, wherein the pushbutton connection is adapted to enable a radio frequency to be set; and (iv) a momentary rocker button displayed by the housing and adapted to make an electrical connection with the printed circuit board, wherein the rocker button connection is adapted to enable the radio volume to be set. In one alternative of this embodiment, the pushbutton is adapted to be illuminated.

One alternative of this embodiment includes another pushbutton displayed by the housing and adapted to make a second electrical connection with the printed circuit board, wherein the second pushbutton connection is adapted to enable the radio frequency band to be set. Another alternative of this embodiment includes an illuminated volume indicator displayed by said housing.

In still another embodiment of the present invention, a turn signal control lever comprises: (i) a housing for attachment to a steering column of an automobile; (ii) a printed circuit board fixed inside the housing; (iii) a pushbutton displayed by the housing and adapted to make an electrical connection with the printed circuit board, wherein the pushbutton connection is adapted to enable information to be communicated to an automobile driver; (iv) a thumbwheel displayed by the housing and adapted to make a plurality of electrical connections with the printed circuit board, wherein the thumbwheel connections are adapted to enable different panel light intensities to be set; and (v) a slide switch displayed by the housing and adapted to make an electrical connection with the printed circuit board, wherein the slide switch connection is adapted to enable the automobile's headlights to be illuminated.

One alternative of this embodiment includes another slide switch displayed by the housing and adapted to make a second electrical connection with the printed circuit board, wherein the second slide switch connection is adapted to enable the automobile's fog lights to be illuminated. In another alternative of this embodiment, the lever is adapted to pivot relative to the steering column to enable a left turn signal and a right turn signal to be illuminated.

An advantage of the present invention is to provide a plurality of simplified and improved multifunctional automobile levers.

Another advantage of the present invention is to provide an improved windshield wiper lever.

A further advantage of the present invention is to provide an improved radio controller.

Still another advantage of the present invention is to provide an improved turn signal control lever.

Additional features and advantages of the present invention will be described in and apparent from the detailed description of the presently preferred embodiments.

### BRIEF DESCRIPTION OF THE FIGURES

A more complete appreciation of the invention and many of the attendant advantages thereof will be readily obtained as the same becomes better understood by reference to the following detailed description when considered in connection with the accompanying drawings, wherein:

FIG. 1 is an exploded perspective view of one embodiment of an improved multifunctional automobile lever illustrating one combination of and configuration input devices;

FIG. 2 is a side elevation view of a straight stalk embodiment of an improved multifunctional automobile lever illustrating another combination of input devices;

FIG. 3 is a side elevation view of a curved stalk embodiment of an improved multifunctional automobile lever illustrating a further combination of input devices;

FIG. 4 is a perspective view of a curved stalk embodiment of an improved multifunctional turn signal lever illustrating a preferred combination of input devices adapted for related turn signal functions;

FIG. 5 is a perspective view of a curved stalk embodiment for an improved multifunctional windshield wiper lever illustrating a preferred combination of input devices adapted for windshield wiper control;

FIG. 6 is a perspective view of a straight stalk embodiment for an improved multifunctional radio controller illustrating a preferred combination of input devices adapted for radio control; and

FIG. 7 is perspective view of a lever exposing internal components, including the contact slider being mated to the rocker button.

### DETAILED DESCRIPTION OF THE PRESENTLY PREFERRED EMBODIMENTS

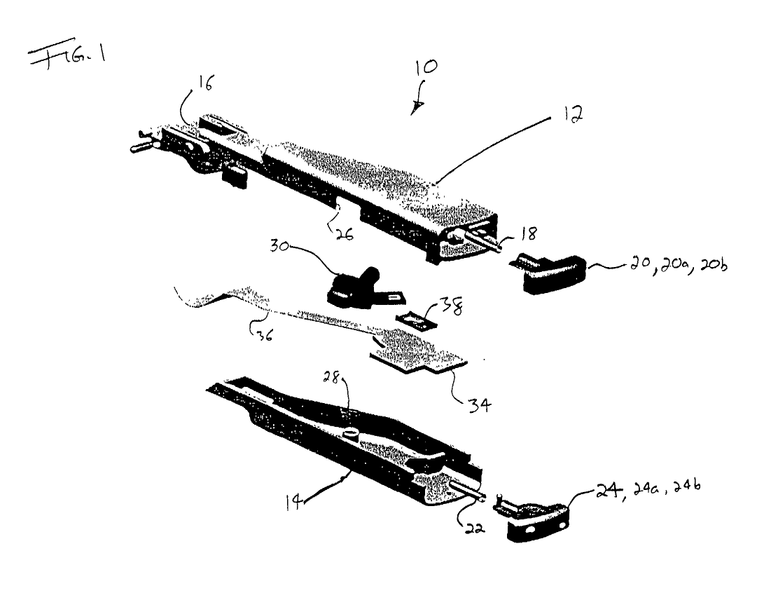

Referring to the drawings, FIG. 1 is an exploded view of one embodiment of an improved multifunctional automobile lever 10 illustrating one preferred combination and configuration of input devices. The lever 10 includes a housing comprised of base 12 and a cover 14. The present invention includes any suitable method of attaching the base 12 to the cover 14 to form the housing, such as using rivets or snapping fitting the components together, etc. Alternatively, the base 12 and cover 14 include one or more aligning mounting holes, wherein one of the base 12 or cover 14 includes a through hole for receiving a screw (not illustrated) and the other of the base 12 or cover 14 includes a tapped hole (not illustrated) for threadingly engaging the screw. Any of these attachment methods can be employed without departing from the scope of the claimed invention.

One end of the base 12 includes the apparatus 16 necessary to mount the lever 10 to a steering wheel column (not illustrated). The apparatus 16 and method for engaging the base 12 to the steering column is well known. The apparatus 16 is preferably adaptable to be mounted to any steering column. Opposite the apparatus 16, the base 12 preferably includes a fixed or integrally attached stem or mounting device 18 upon which a pushbutton 20 is moveably attached. On the same end that the base 12 includes the mounting device 18, the cover 14 includes a fixed or integrally attached stem or mounting device 22 upon which a rocker button 24 is moveably attached. The base 12 also preferably includes a notch 26 and the cover 14 preferably includes a pivot 28, whereby a thumbwheel 30 rotatably attaches to the pivot 28 and a portion of the thumbwheel extends through the notch 26 of the cover 14 for manual engagement.

FIG. 1 illustrates one possible configuration for the lever 10 having a pushbutton 20, and rocker button 24 and a thumbwheel 30. The lever 10 includes either the base 12 or the cover 14 having the moveably attached pushbutton 20 or the moveably attached rocker button 24. The lever 10 also includes mounting the thumbwheel 30 on the end of either the base 12 or the cover 14. The lever 10 further includes mounting either or both of the pushbutton 20 or the rocker button 24 along the top of, bottom of or on one of the elongated faces or sides of the housing, as is the thumbwheel 30 in FIG. 1. In any of these various configurations, the lever 10 includes moveably attaching a plurality of pushbuttons 20, a plurality of rocker buttons 24 and a plurality of thumbwheels 30 (generally “input devices” includes to each of these as well as a slide switch 32 discussed below).

Each of these well know input devices makes its own electrical connection as is described in detail below. It is not necessary to mechanically link the movements of these devices to other apparatus (e.g., contact slides, springs, detents, ect.) to obtain a specific electrical connection. Therefore, much of the complexity of former systems can be eliminated. As described later, however, the lever 10 still includes a printed circuit board and one or more contact slides in certain desired situations.

The pushbutton 20 includes any known switch, wherein the automobile driver presses a self-contained spring loaded button to make an electrical contact or connection. The pushbutton 20 includes closing an electrical path and allowing current to flow from point A to point B. The pushbutton 20 also includes closing a contact and allowing current to flow from a conductive path A-A to a conductive path B-B. The pushbutton 20 is preferably normally open such that no current flows when the in switch is an inactive state (i.e., driver is not pressing the button). However in certain instances, the pushbutton 20 includes being normally closed. The pushbutton 20 is preferably electrically rated for the output voltage and current of the automobile's control system, as is the rocker button 24 and the thumbwheel 30 and any other type of switch disclosed herein.

The pushbutton 20 includes being a momentary pushbutton 20a or a latching pushbutton 20b. With the momentary pushbutton 20a, when the automobile driver stops pressing the button, the spring in the button opens the switch and current flow discontinues as does the associated automobile function. The lever 10 includes using the momentary pushbutton 20a to enable or initiate many automobile functions including: (i) a front or rear windshield wash; (ii) a single or temporary windshield wipe; (iii) a radio frequency scan or seek or a radio frequency band selection; and (iv) a momentary illumination of an interior or exterior light.

With the latching pushbutton 20b, when the automobile driver stops pressing the button, the button and the switch remain closed and current flow continues. The driver must press the latching pushbutton 20b again or press a separate release button (not illustrated) in order to unlatch the button and stop current flow and thereby halt the associated automobile function. The lever 10 employs using the latching pushbutton 20b to enable or initiate many automobile functions including: (i) turning a front or rear windshield wiper on or off; (ii) setting a windshield wiper at a particular speed; (iii) turning a radio on or off; (iv) turning an interior or exterior light on or off; and (v) turning a turn signal on or off.

The rocker button 24 is essentially two pushbuttons in a single switch and therefore is visually useful for higher/lower momentary features or on/off latching or maintained features. That is, if pushed in one direction, the rocker button closes an electrical path and allows current to flow from point A to point B or closes a contact and allows current to flow from a conductive path A-A to a conductive path B-B. And, if pushed in another direction, the rocker button closes an electrical path and allows current to flow from point C to point D or closes a contact and allows current to flow from a conductive path C-C to a conductive path D-D.

The rocker button 24 also includes being momentary or latching. The rocker button 24 further includes being a two position button 24a or three position button 24b. The two position rocker button 24a has three possible configurations and three different uses.

First, the two position rocker button 24a includes maintaining a function in an active state if pushed in one direction and maintaining the same function in an inactive state if pushed in the other direction. In one embodiment, the rocker button 24a includes maintaining the outside headlights in an illuminated state if pushed in one direction and turning the headlights off if pushed in the other direction.

Second, the two position rocker button 24a includes maintaining a first activated function if pushed in one direction and maintaining a second activated function if pushed in the other direction. In one embodiment, the rocker button 24a includes maintaining illuminated headlights if pushed in one direction and maintaining illuminated fog lights if pushed in the other direction. It should be appreciated that if the headlights are on, the fog lights are off and vice versa.

Third, the two position rocker button 24a includes momentarily activating a first function if pushed in one direction and maintaining a second function if pushed in the other direction. In one embodiment, the rocker button 24a includes momentarily illuminating the fog lights if pushed in one direction and maintaining the headlights in an illuminated state if pushed in the other direction. Again, it should be appreciated that if the headlights are on, the fog lights are off and vice versa.

When the two position rocker button 24a activates two separate functions, e.g., the headlights or the fog lights, one of the two is always activated. To turn both off, another switch, e.g., an enable outside lighting switch, is necessary. The three position rocker button 24b provides the extra switch or state. The three position rocker button 24b also has three possible configurations and three different uses.

First, the three position rocker button 24b includes momentarily activating a first function if pushed in one direction, momentarily activating a second function if pushed in the other direction and not activating either if left in the off position. In one embodiment, the rocker button 24b includes scanning or seeking a higher radio frequency if pushed in one direction, scanning or seeking a lower radio frequency if pushed in the other direction and not scanning or seeking a radio frequency if left alone.

Second, the three position rocker button 24b includes momentarily activating a first function if pushed in one direction, maintaining a second function in an activated state if pushed in the other direction and not activating either if left in the off position. In one embodiment, the rocker button 24b includes momentarily illuminating an interior light if pushed in one direction, maintaining an interior light in an illuminated state if pushed in the other direction and providing no interior illumination if left alone.

Third, the three position rocker button 24b includes maintaining a first function in an activated state if pushed in the one direction, maintaining a second function in an activated state if pushed in the other direction and not activating either if left in the off position. In one embodiment, the rocker button 24b includes maintaining the headlights in an illuminated state if pushed in the one direction, maintaining the fog lights in an activated state if pushed in the other direction and providing no exterior illumination if left alone.

The thumbwheel 30 enables the driver to set one of a plurality of maintained contacts. The thumbwheel 30 includes a plurality of line contacts, e.g., line contacts 0 through 9, and one or more neutral or common contacts. The thumbwheel 30 also includes having a decimal output code, a binary coded decimal (“BCD”) output code or a hexadecimal output code. The thumbwheel 30 further preferably includes a wheel or rotatable member, which contains a plurality of detents. When the driver sets the wheel to a first detent position, the thumbwheel 30 makes a first maintained contact closure, e.g., between line 0 and neutral. When the driver sets the wheel to a second detent position, the thumbwheel 30 makes a second contact closure, e.g., between line 1 and neutral.

The thumbwheel 30 includes having any number of detent positions, one of which may be an off position. In one embodiment, the thumbwheel controls an instrument panel lighting dimmer switch. If the automobile manufacturer wishes to provide four panel illumination settings, the thumbwheel 30 includes having five detent positions, wherein one position turns the instrument panel light off. Alternatively, the thumbwheel 30 includes having four detent positions, one for each illumination setting, wherein a separate switch enables or disables the panel light. Especially in the case of interior or exterior lighting, the manufacturer may desire to provide a separate enabling switch to help prevent the driver from leaving a light on, e.g., in the daytime or at a low dimmer setting, and needlessly draining the battery.

The thumbwheel 30 includes controlling a plurality of different functions as described below. The thumbwheel 30 also includes having a variety of driver interfaces with which the driver adjusts the thumbwheel setting. The thumbwheel 30 includes providing the actual detents of the rotating wheel, a single projection as illustrated in FIGS. 2 through 5 or any other type of interface that preferably enables the driver to adjust the wheel either blindly via touch or feel or with limited viewing. The thumbwheel 30 also includes being a well known “pushwheel” type, which includes a spring loaded pushbutton for incrementing to a higher number contact and another spring loaded pushbutton for incrementing to a lower number contact.

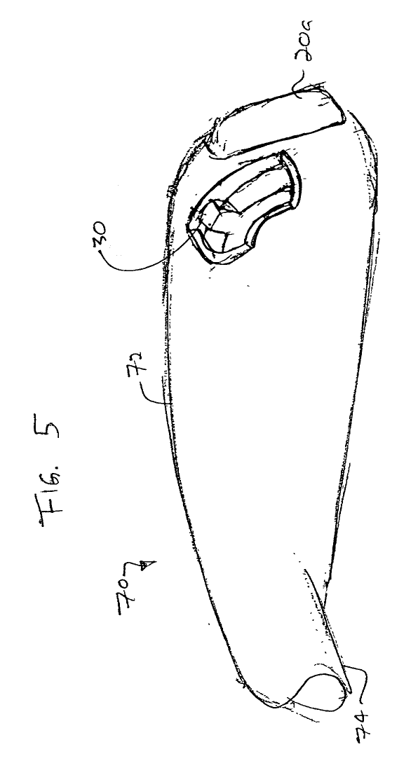

Referring briefly to FIGS. 2 and 4, although not illustrated in FIG. 1, the lever 10 also includes having one or more slide switches 32 as illustrated in FIGS. 2 and 4. The lever 10 includes having one or more slide switches 32 in addition to one or more pushbuttons 20, one or more rocker buttons 24 and one or more thumbwheels 30. The lever 10 alternatively includes having one or more slide switches 32 in place of one or more of the pushbuttons 20, the rocker buttons 24 and the thumbwheels 30. Preferred combinations of the input devices are discussed below.

The slide switches 32 characteristically have a lever or actuator that the driver moves either momentarily to another position or to a maintained position. As defined in this disclosure, the actuator includes being a well known toggling device, such that the term “slide switches,” as used herein, includes toggle switches. In certain embodiments, the slide switches operate exactly as described with the two position and three position rocker buttons 24a and 24b, including each of the six combinations disclosed. FIGS. 2 and 4 illustrate a three position slide switch 32, wherein the top position is the off or no activation position. In the three position rocker button 24b, the middle position, i.e., when the button 24b is not pressed one way or the other, is the off or no activation position.

The slide switches 32 include having four or more positions, whereas the rocker button 24 preferably has two or three. When the slide switches 32 have four or more maintained positions, they operate similar to the thumbwheel 30. The slide switches include one or more line contacts and one or more neutral or common contacts.

Each of the different switches herein described, including the pushbuttons 20, the rocker buttons 24, the thumbwheels 30 and the slide switches 32 includes being back mounted or panel mounted, which are both well known methods of mounting many types of electromechanical components. FIG. 1 illustrates that the pushbutton 20, the rocker button 24 and the thumbwheel 30 are each back mounted. That is, the input devices preferably snap or press-fit onto a mounting device fixed to the base 12 or cover 14, i.e., the stems 18 and 22 and the pivot 28, respectively.

If panel mounted, the preferably plastic, e.g., polycarbonate, input devices include well known plastic snaps that enable the input devices press-fit or snap-fit into the housing. Alternatively, the lever 10 includes employing one or more fastening devices such as a screw, a rivet, glue or epoxy to panel mount the input devices. The lever 10 further includes threading one or more input devices, e.g., a threaded pushbutton 20 or a threaded toggle switch 32 and threadingly engaging the input device with a mating set of threads integral to the base 12 or cover 14.

In a further alternative embodiment, the lever 10 includes surface mounting one or more of the input devices to a PCB 34. Surface mount versions of the input devices herein described are adapted: (i) to withstand the temperatures of wave or reflow soldering; (ii) to withstand washing of the PCB 34 to remove flux residue; and (iii) to have leads designed to be placed either into through holes in the PCB 34 for wave soldering or onto pasted pads of the PCB 34 for reflow soldering. Surface mounting the input devices to the PCB 34 provides the mechanical and electrical connection for the input devices.

When back mounting or panel mounting the input devices to the housing of the lever 10, separate electrical connections must be made from the input devices to the PCB 34. The pushbuttons 20, the rocker buttons 24, the thumbwheels 30 and the slide switches 32 each include a plurality of well known methods of electrically connecting to the PCB 34. In one method, the input devices include preferably copper or copper alloy contacts (either of which can be silver plated), which have solder eyelets for individually soldering wires to the contacts, wherein the wires are likewise soldered or plugged into the PCB 34 or into a quick disconnect attached thereto. In another method, the input devices have plugs or jacks that plug into an adapter, which has corresponding wires that are soldered or plugged into the PCB 34 or into a quick disconnect attached thereto. The present invention includes employing any known connection techniques for attaching wires to the PCB 34 including suitable wire strain relief features.

The PCB 34 is either pressed in place between the base 12 and the cover 14 or bolted or otherwise suitable adhered to one of the base 12 or cover 14. The PCB 34 is preferably readily removable for maintenance purposes. The PCB 34 is preferably a remote input output controller that includes a Read Only Memory (ROM) chip that allows the lever to communicate either to the SCM base or main PCB or directly to vehicle body controller via a LIN or CAN bus. The bus communication greatly reduces the number of wires exiting the lever, thereby improving the performance of the system. The lever still requires switching pads on the PCB, however there is no need for discrete resistors to create a resistive ladder network. The switches have a direct switch to ground input or, if necessary, a binary code input to the ROM chip.

Standard I/O boards control 8 or 24 discrete digital or analog inputs or outputs and are chosen based on the total number of I/O needed for the lever 10. The PCB 34 in one embodiment includes one or more quick disconnect I/O connectors for connecting wires from the input devices of the lever 10 and for connecting a ribbon 36 that extends into the steering column and beyond. The ribbon 36 holds the wires for the functional devices as well as wires for powering the PCB 34. The PCB 34 also includes, for some of the embodiments discussed below, one or more white or colored lights or lamps, such as surface mounted LED's, which selectively back light either an input device directly or graphical information associated with the input device.

The PCB 34 also includes one or more contact sliders 38 that translate the rotational motion of a rocker button 24 or thumbwheel 30 into a linear translation or movement. The contact sliders 38 engage copper traces imbedded in the PCB 34. In one preferred embodiment, the contact sliders 38 include one or more U-shaped copper contacts that engage or electrically communicate with two or more traces in the PCB 34, such that the U-shape completes a circuit which initiates an automobile function. All lever switches require a switching contact. FIG. 7 shows a contact slider 38 mated with a rocker button 24.

The foregoing explanation of the each of the components and input devices of the lever 10 applies to each of the alternative embodiments of the multifunctional automobile lever described below. Referring now to FIG. 2, a side elevation view of another preferred combination of input devices illustrates that the lever 40 includes a housing 42 that is integral to or permanently attached to straight stalk 44, i.e., the section of the lever 40 that extends to the apparatus (apparatus 16 in FIG. 1) for attaching the lever 40 to the steering column.

The lever 40 has replaced the pushbutton 20 of FIG. 1 with a plurality of angled slide switches 32. The angle of the slide switches 32 is preferably adapted to counteract the angle at which the lever 40 extends from the steering column, so that the slide switches 32 appear horizontal to the automobile driver. The lever 40 also includes a rocker button 24 (two position 24a or three 24b) and a thumbwheel 30.

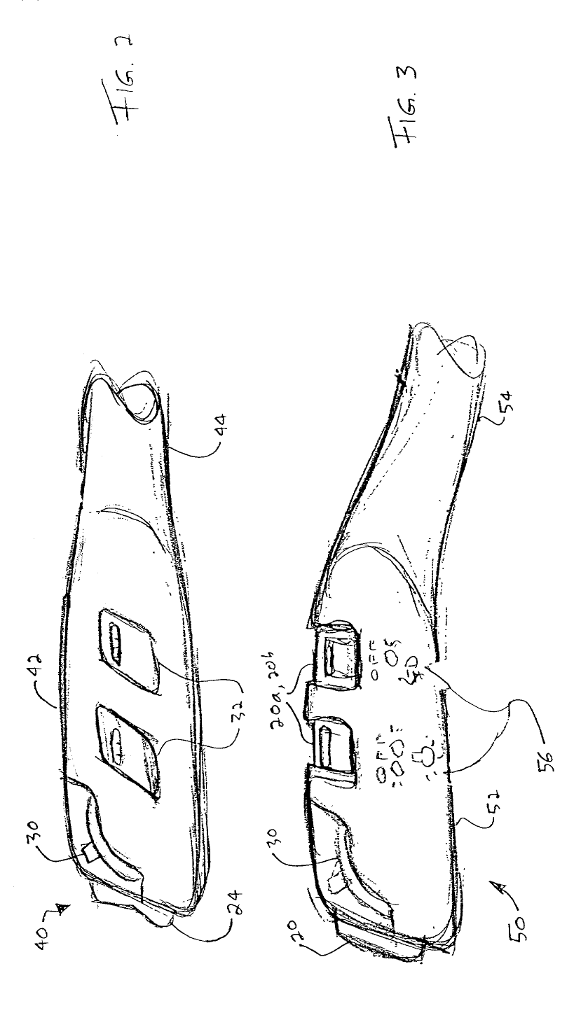

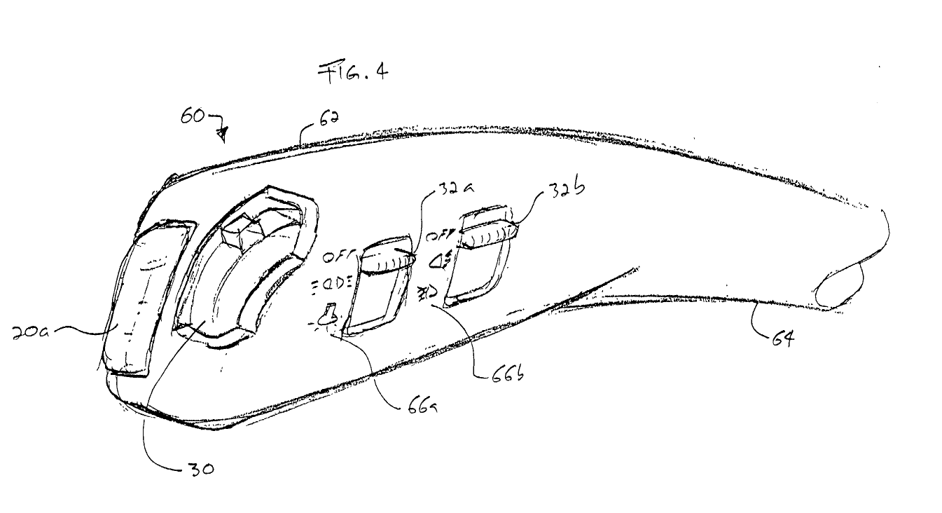

Referring now to FIG. 3, a side elevation view of a further preferred combination of input devices illustrates that the lever 50 includes a housing 52 that is integral to or permanently attached to a curved stalk 54 for attaching the lever 50 to the steering column. The angle of the stalk 54 is preferably adapted to counteract the angle at which the lever 50 extends from the steering column, so that the housing 52 appears horizontal to the automobile driver. The momentary or latching pushbuttons 20a or 20b are therefore not angled.

The lever 50 includes another pushbutton 20 and a thumbwheel 30 on its end. Any portion or portions including all of the housing 52 of the lever 50 (and any of the levers described herein) includes being translucent, such that the lamps of the PCB selectively illuminate the translucent portion when a particular function has been activated. Preferably the cover 14 (FIG. 1) but alternatively any portion of the housing 52 of the lever 50 (and any of the levers described herein) includes having pad printed or laser etched indicia or graphics 56, which provide information to the driver.

Referring now to FIG. 4, a perspective view of a preferred turn signal lever 60 illustrates that the lever 60 includes a housing 62 that is integral to or permanently attached to a curved stalk 64 for attaching the lever 60 to the steering column. It should be appreciated that the preferred turn signal lever 60 also includes having a straight stalk. A preferably momentary pushbutton 20a on the end of the housing 62 provides information to the driver. The information is usually provided to the driver via a visual display elsewhere in the vehicle by way of a heads up display or a LCD panel. A thumbwheel 30 preferably controls various illumination settings for the instrument panel lights. As described above, the thumbwheel 30 includes having or not having an off or no illumination position for the panel lights. The thumbwheel 30 alternatively controls various illumination settings for the interior lights or for the exterior headlights.

A plurality of maintained slide switches 32a and 32b control the exterior headlights and the exterior fog lights, respectively. Each slide switch has three positions, wherein the top position is an off position. The switch 32a contains positions for “OFF,” “Park Lamp,” and “Head Lamps On,” as indicated by the graphics 66a. The switch 32b contains positions for “OFF,” “Front Fog Lamp,” and “Rear Fog Lamp,” as indicated by the graphics 66b. Although not illustrated, the turn signal lever 60 also pivotally connects to the steering column so that the driver can pivot the lever 60 downward to initiate a maintained left turn signal or pivot the lever 60 upward to initiate a maintained right turn signal, as is well known.

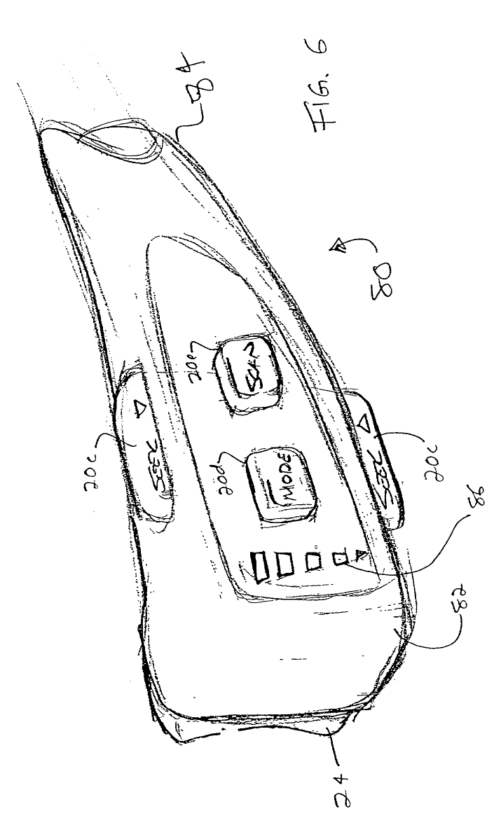

Referring now to FIG. 5, a perspective view of a preferred windshield wiper lever 70 illustrates that the lever 70 includes a housing 72 that is integral to or permanently attached to a curved stalk 74 for attaching the lever 70 to the steering column. It should be appreciated that the preferred wiper lever 70 also includes having a straight stalk. A preferably momentary pushbutton 20a on the end of the housing 72 initiates a temporary or momentary front or rear windshield wash. A thumbwheel 30 preferably controls various wiper speed settings for front or rear windshield wipers. As described above, the thumbwheel 30 includes having or not having an off or no wipe position for the windshield wipers.

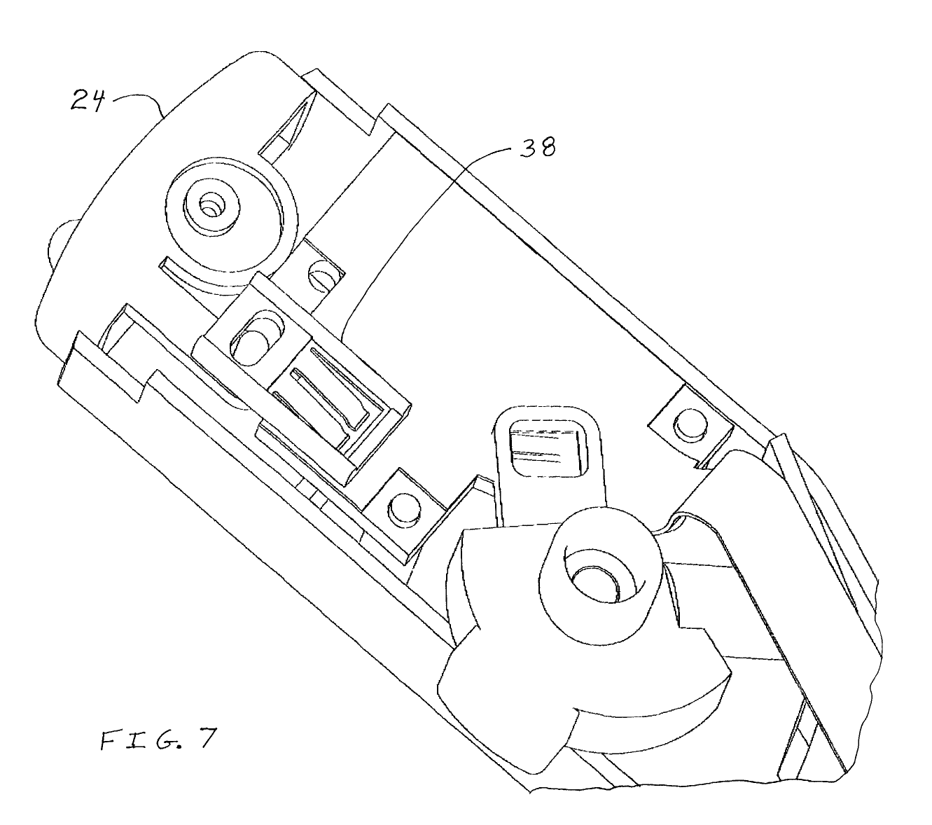

Referring now to FIG. 6, a perspective view of a preferred redundant radio controller 80 illustrates that the controller 80 includes a housing 82 that is integral to or permanently attached to a straight stalk 84 for attaching the controller 80 to the steering column. It should be appreciated that the preferred radio controller 80 also includes having a curved stalk. A plurality of preferably momentary pushbuttons 20c, 20d and 20e control the well known radio frequency seek, the radio frequency band selection and the radio frequency scan functions, respectively. The controller 80 illustrates translucent, indicia bearing input devices, wherein the SEEK button 20c, MODE button 20d and SCAN button 20e include being translucent, being illuminated and having indicia. It should be appreciated that any of the embodiments disclosed herein include having translucent, indicia bearing input devices.

The back side or base 12 (see FIG. 1) of the housing 82 includes a preferably two position momentary/momentary rocker button 24a, which enables the driver to blindly turn the radio volume up or down. The driver simply feels for the rocker button 24a and pushes it up to turn the volume up and pushes it down to turn the volume down. An illuminating indicator 86 on the cover of the housing 82 directly across from the volume rocker button 24a sequentially adds lights from bottom to top or subtracts lights from top to bottom to indicate a volume increase or decrease, respectively. The illuminating indicator 86 includes a particular light corresponding or not corresponding to a particular decibel or decibel range.

It should be understood that various changes and modifications to the presently preferred embodiments described herein will be apparent to those skilled in the art. Such changes and modifications may be made without departing from the spirit and scope of the present invention and without diminishing its attendant advantages.

We claim:

1. A multifunctional automobile lever comprising:
a housing for attachment to a steering column of an automobile;
a printed circuit board fixed inside the housing;
a pushbutton displayed by the housing and adapted to make an electrical connection with the printed circuit board;
a thumbwheel displayed by the housing and adapted to make an electrical connection with the printed circuit board; and
a rocker button displayed by the housing and adapted to make an electrical connection with the printed circuit board.

2. The lever of claim 1, wherein the pushbutton is adapted to make a latching electrical connection with the printed circuit board.

3. The lever of claim 1, wherein the pushbutton is adapted to make a momentary electrical connection with the printed circuit board.

4. The lever of claim 1, which includes a plurality of pushbuttons, each adapted to make an electrical connection with the printed circuit board.

5. The lever of claim 1, wherein the thumbwheel is adapted to make a plurality of electrical connections with the printed circuit board.

6. The lever of claim 1, wherein the rocker button is adapted to make a plurality of electrical connections with the printed circuit board.

7. The lever of claim 1, wherein the rocker button is adapted to make a latching electrical connection with the printed circuit board.

8. The lever of claim 1, wherein the rocker button is adapted to make a momentary electrical connection with the printed circuit board.

9. The lever of claim 1, wherein at least a portion of the housing is translucent.

10. The lever of claim 1, wherein the housing includes graphics adapted to be illuminated.

11. The lever of claim 1, which includes a slide switch displayed by the housing and adapted to make an electrical connection with the printed circuit board.

12. The lever of claim 1, wherein the housing is angled so that a front facing input device thereon appears substantially horizontal.

13. The lever of claim 1, wherein a front facing input device is angled to appear substantially horizontal.

14. A multifunctional automobile lever comprising:
a housing for attachment to a steering column of an automobile;
a printed circuit board fixed inside the housing;
a slide switch displayed by the housing and adapted to make an electrical connection with the printed circuit board;
a thumbwheel displayed by the housing and adapted to make an electrical connection with the printed circuit board; and
a rocker button displayed by the housing and adapted to make an electrical connection with the printed circuit board.

15. The lever of claim 14, which includes a plurality of slide switches, each adapted to make an electrical connection with the printed circuit board.

16. The lever of claim 14, wherein at least a portion of the housing includes graphics adapted to be illuminated.

17. A multifunctional automobile lever comprising:
a housing for attachment to a steering column of an automobile;
a printed circuit board fixed inside the housing;
a plurality of pushbuttons, each displayed by the housing and adapted to make an electrical connection with the printed circuit board; and
a thumbwheel displayed by the housing and adapted to make an electrical connection with the printed circuit board.

18. The lever of claim 17, which includes a slide switch moveably attached to the housing and adapted to make an electrical connection with the printed circuit board.

19. A windshield wiper control lever comprising:
a housing for attachment to a steering column of an automobile;
a printed circuit board fixed inside the housing;
a momentary pushbutton displayed by the housing and adapted to make an electrical connection with the printed circuit board, wherein the pushbutton connection is adapted to enable a windshield wiper wash; and
a thumbwheel displayed by the housing and adapted to make a plurality of electrical connections with the printed circuit board, wherein the thumbwheel connections are adapted to enable different wiper speeds to be set.

20. A radio controller for an automobile comprising:
a housing for attachment to a steering column of an automobile;
a printed circuit board fixed inside the housing;
a pushbutton displayed by the housing and adapted to make an electrical connection with the printed circuit board, wherein the pushbutton connection is adapted to enable a radio frequency to be set; and
a momentary rocker button displayed by the housing and adapted to make an electrical connection with the printed circuit board, wherein the rocker button connection is adapted to enable the radio volume to be set.

21. The radio controller of claim 20, which includes another pushbutton displayed by the housing and adapted to make a second electrical connection with the printed circuit board, wherein the second pushbutton connection is adapted to enable the radio frequency band to be set.

22. The radio controller of claim 20, wherein the pushbutton is adapted to be illuminated.

23. The radio controller of claim 20, which includes an illuminated volume indicator displayed by said housing.

24. A turn signal control lever comprising:
a housing for attachment to a steering column of an automobile;
a printed circuit board fixed inside the housing;
a pushbutton displayed by the housing and adapted to make an electrical connection with the printed circuit board, wherein the pushbutton connection is adapted to enable information to be communicated to an automobile driver;
a thumbwheel displayed by the housing and adapted to make a plurality of electrical connections with the printed circuit board, wherein the thumbwheel connections are adapted to enable different panel light intensities to be set; and
a slide switch displayed by the housing and adapted to make an electrical connection with the printed circuit board, wherein the slide switch connection is adapted to enable the automobile's headlights to be illuminated.

25. The turn signal control lever of claim 24, which includes another slide switch displayed by the housing and adapted to make a second electrical connection with the printed circuit board, wherein the second slide switch connection is adapted to enable the automobile's fog lights to be illuminated.

26. The turn signal control lever of claim 24, wherein the lever is adapted to pivot relative to the steering column to enable a left turn signal and a right turn signal to be illuminated.
